(19) United States
(12) Patent Application Publication
(10) Pub. No.: US 2025/0276912 A1
(43) Pub. Date: Sep. 4, 2025

(54) METHOD FOR PRODUCING NICKEL-RICH CATHODE ACTIVE MATERIAL AND METHOD FOR PRODUCING CATHODE ELECTRODE

(71) Applicant: L'Air Liquide, Société Anonyme pour l'Etude et l'Exploitation des Procédés Georges Claude, Paris (FR)

(72) Inventors: Sanghoon KIM, Yokohama (JP); Laurent PROST, Yokohama (JP); Francis BRIAND, Paris (FR)

(21) Appl. No.: 18/858,961

(22) PCT Filed: Apr. 14, 2023
(86) PCT No.: PCT/EP2023/059766

§ 371 Date: Oct. 22, 2024

(30) Foreign Application Priority Data
Apr. 22, 2022 (JP) 2022-070464

(51) Int. Cl. C01G 53/506

(52) U.S. Cl. CPC C01G 53/506; C01P 2002/70; C01P 2006/40

(57) ABSTRACT

To provide: a range of gas mixture compositions that make it possible to hinder Li/Ni cation mixing and transition metal peroxidation; and a method for producing a nickel-rich cathode active material, comprising a firing process using the gas mixtures. The method for producing a nickel-rich cathode active material comprises a firing step, in which a cathode precursor containing at least a predetermined amount of nickel, and a metal oxide solid raw material containing lithium raw material, are fired in a reactor having an atmosphere comprising a gas mixture containing oxygen in the range of 94% by volume to 98% by volume. The oxygen content of the gas mixture is preferably 95% by volume to 97% by volume.

### CROSS REFERENCE TO RELATED APPLICATIONS

This application is a 371 of International Application No. PCT/EP2023/059766, filed Apr. 14, 2023, which claims priority to Japanese Patent Application No. 2022-070464, filed Apr. 22, 2022, the entire contents of which are incorporated herein by reference.

### TECHNICAL FIELD

The present disclosure relates to a method for producing a nickel-rich cathode active material and to a method for producing a cathode electrode. Nickel-rich cathode active materials are used in the cathode electrodes of lithium-ion secondary batteries.

### BACKGROUND ART

Patent Document 1 states that a mixture of a composite oxide precursor and lithium is fired in an oxidizing gas atmosphere such as air in a furnace at a temperature ranging from 700° C. to 1000° C.

Patent Document 2 discloses a method for producing a nickel-rich cathode that contains no residual lithium by means of a two-step firing process, at a low temperature and at a high temperature, in a pre-heated air atmosphere.

Patent Document 3 (paragraph of the specification) states that a precursor powder is decomposed for 4 hours at 450° C. in an oxygen stream and is ground into a fine powder, which is fired for 12 hours at 900° C. under conditions involving an oxygen stream.

Patent Document 4 (Claim 1) states that a solid mixture is fired for about 4 hours to about 12 hours at a temperature of about 600° C. to about 900° C. in an atmosphere having an oxygen content higher than 21%.

Non-Patent Document 1 describes a nickel-rich cathode active material that has been fired in pure oxygen.

Non-Patent Document 2 describes the effects of gas atmosphere while nickel-rich cathode active materials are being fired. The effects are assessed using 100% oxygen and the following gas mixtures: 50% oxygen and 50% nitrogen; 21% oxygen and 79% nitrogen; and 5% oxygen and 95% nitrogen. It is stated that the best fired material was obtained in 100% oxygen, resulting in favorable properties in terms of nickel and lithium mixing as well as the best electrochemical performance.

Non-Patent Document 3 describes the effects of firing temperature on nickel-rich cathode active materials. It is stated that the best firing temperature was in the range of 750° C. to 775° C., resulting in favorable properties in terms of nickel and lithium mixing as well as the best electrochemical performance.

### PRIOR ART DOCUMENTS

Patent Document 1 EP 3636597 (A1)

Patent Document 2—U.S. Pat. No. 7,648,693 (B2)

Patent Document 3—Japanese Translation of PCT International Application 2021-517707

Patent Document 4—Japanese Translation of PCT International Application 2019-503063

### Non-Patent Literature

Non-Patent Literature 1—Electrochim. Acta, 2014, No. 138, pp. 15-21

Non-Patent Literature 2—J. Power Sources, 2015, No. 283, pp. 211-218

Non-Patent Literature 3—Nano Energy, 2018, No. 49, pp. 538-548

### SUMMARY OF THE INVENTION

Nickel-rich cathodes are commonly prepared by an expensive process in a specialized reactive atmosphere, such as pure oxygen, moisture-free pure oxygen, or a preheated stream of air. The lack of an oxygen atmosphere (that is, a lack of oxygen) during firing can lead to a loss of chemical or structural stability as well as to a reduced number of cycles and lower capacity in lithium-ion battery applications. Thus, in cases where nickel-rich cathodes are used in lithium-ion batteries, there is a need to develop a method for preparing a nickel-rich cathode active material that would enable better chemical and structural stability (such as low Li/Ni cation mixing) as well as better cycling capacity and higher capacity, for example.

There has been much research on the identification and development of layered metal oxide-based materials for the positive electrode active materials that are used in lithium-ion batteries. Among the broad range of layered oxides that have been found, the most promising candidates in terms of greater nickel content are NMC811 (lithium-nickel-manganese-cobalt oxide having an Ni:Mn:Co molar ratio of 80:10:10) and NCA (lithium-nickel-cobalt-aluminum oxide having an Ni:Co:Al molar ratio of 85:15:5). These are only active redox pairs, which enable the intercalation (or de-intercalation) of more lithium ions in layered structures, thereby providing higher capacity. The correspondingly greater nickel content and lower cobalt and manganese content in nickel-rich cathodes lead to correspondingly greater oxidation of nickel, from 2⁺ in NMC111 to 2.9⁺ in NMC811, for example. As a result, transition metal slabs containing nickel, cobalt, and manganese (or aluminium) become less stable, because of the insufficient cobalt content, and the Ni³⁺—O bonds in nickel-rich cathodes are chemically stabilized. Ni³⁺ also tends to be reduced to Ni²⁺ and, because the ionic radii of Ni²⁺ and Li⁺ are similar, is irreversibly exchanged with Li⁺ during charging cycles and even during production. This phenomenon, referred to as Li/Ni cation mixing, is a cause of low initial capacity, low long-term cycling, and low C-rate performance when nickel-rich cathodes are used in lithium-ion batteries. The ongoing site exchange between nickel and lithium may also lead to the evolution of circulating gas (O₂) and structural breakdown, the latter of which may lead to further oxidation of the electrolyte and ultimately to battery failure.

An oxidizing environment, such as pure oxygen, is commonly used in the firing process to minimize Li/Ni cation mixing during the production of nickel-rich cathodes. However, even though pure oxygen can ensure a very highly oxidizing environment in furnaces, pure oxygen also leads to surface particle peroxidation of cobalt, manganese, and other elements (except nickel). This results in phase segregation, which can impede lithium ion migration during battery cycling. There is thus a need to develop a method of production capable of addressing both Li/Ni cation mixing and peroxidation of transition metals on the surface of nickel-rich cathodes in order to improve the initial capacity, long-term cycling, and C-rate performance of nickel-rich based cathode materials.

The present disclosure provides a range of gas mixture compositions that make it possible to hinder Li/Ni cation mixing and transition metal peroxidation.

The present disclosure also provides a method for producing a nickel-rich cathode active material, comprising a firing process in which the above gas mixtures are used.

The present disclosure furthermore provides a method for producing a cathode electrode using the nickel-rich cathode active material.

The method for producing a nickel-rich cathode active material according to the present disclosure comprises:
a firing step, in which a cathode precursor containing at least a predetermined amount of nickel, and a metal oxide solid raw material containing lithium raw material, are fired in a reactor having an atmosphere of a gas mixture containing oxygen in the range of 94% by volume to 98% by volume.

The oxygen content of the gas mixture is preferably 95% by volume to 97% by volume.

The gas components other than the oxygen in the gas mixture may comprise one or more selected from argon, nitrogen, helium, and krypton

When the gas component other than oxygen is argon, the argon content may 2% by volume to 5% by volume.

When the gas components other than oxygen are argon and nitrogen, the argon content (% by volume) is preferably greater than the nitrogen content.

When the gas components other than oxygen are argon and nitrogen, the nitrogen content may be 0% by volume to 2% by volume.

When the gas component other than oxygen is helium or krypton, the helium or krypton content may be 0% by volume to 1% by volume, or may be 2% by volume to 5% by volume.

In the firing step, the amount of the gas mixture that is used may range from 0.5 kg to 6 kg per 1 kg of the metal oxide solid raw material (lithium raw material and cathode precursor) (metal oxide raw material:gas mixture=1:0.5-6).

The component ratio of the gas mixture may be established depending on the content of the Ni, Co, Mn, and/or nickel-rich cathode doping elements, as well as the firing temperature, heating rate, and production batch size.

The lithium raw material and cathode precursor may be mixed in a molar ratio (specifically, mol of lithium raw material/mol of cathode precursor) of 0.8 to 1.2, and more preferably 0.9 to 1.1.

The lithium raw material may contain one or more selected from LiOH, LiOH·H₂O, and Li₂CO₃.

The cathode precursor may contain one or more selected from M(OH)₂, MOOH, and MCO₃. M is one, or a mixture of two or more, selected from Ni, Co, Mn, Al, and A defined in Formula I above (where A may be referred to as a “doping element” or “dopant”).

The method for producing the nickel-rich cathode active material may include a precursor preparation step for preparing the cathode precursor, as well as a step for producing the solid raw material of metal oxide, prior to the firing step.

The method for producing the nickel-rich cathode active material may include a washing step in which the nickel-rich cathode active material obtained in the firing step is washed to remove excess lithium and impurities and/or a coating step for coating the nickel-rich cathode active material, after the firing step.

The nickel-rich cathode active material that is produced is represented by the following Formula (1).

LiₐNiₓMn_{y}Co_{z}AₖO₂ (1)
A: dopant
0.9<a<1.1

$$x + y + z + k = 1$$

$$x \geq 0. 8$$

The values of x, y, z, and k indicate molar ratio, and the value of a indicates a molar ratio independent of the other elements.

The method may furthermore comprise an electrode production step for producing an electrode using the nickel-rich cathode active material obtained by the method noted above.

The method for producing the cathode electrode in the present disclosure comprises an electrode production step for producing a cathode electrode using the nickel-rich cathode active material that has been produced by the above method for producing a nickel-rich cathode active material.

In the lithium-ion secondary battery in the present disclosure, the nickel-rich cathode active material that has been produced by the above method of production may be included as the cathode active material.

The composition of the gas mixture makes it possible to improve the stability of transition metal slabs in the structure of the nickel-rich cathode active material.

The use of the active material in lithium-ion secondary batteries ensures long-term cycling, high initial capacity, and favorable C-rate performance.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a flow chart of the production method in Embodiment 1.

FIG. 2A shows the capacity per number of cycles in examples.

FIG. 2B shows the capacity per number of cycles in examples.

FIG. 3 shows the c/a ratio in X-ray powder diffractometry (XRD) in examples.

FIG. 4 shows the relative discharge capacity (C-rate) in examples.

### DETAILED DESCRIPTION OF PREFERRED EMBODIMENTS

Several embodiments of the present invention will be described below. The embodiments described below illustrate examples of the present invention. The present invention is in no way limited by the following embodiments, and also includes a number of variant modes which may be implemented without altering the gist of the present invention. It should be noted that not all of the components described below are essential components of the present invention.

### Definition of Terms

In the present specification, standard abbreviations for elements from the Periodic Table of the Elements are used. Elements may therefore be represented by these abbreviations. For example, Li means lithium, Ni means nickel, Mn means manganese, Co means cobalt, and O means oxygen. The same is true for other elements.

As used in the present specification, XRD means X-ray powder diffractometry.

### Embodiment 1

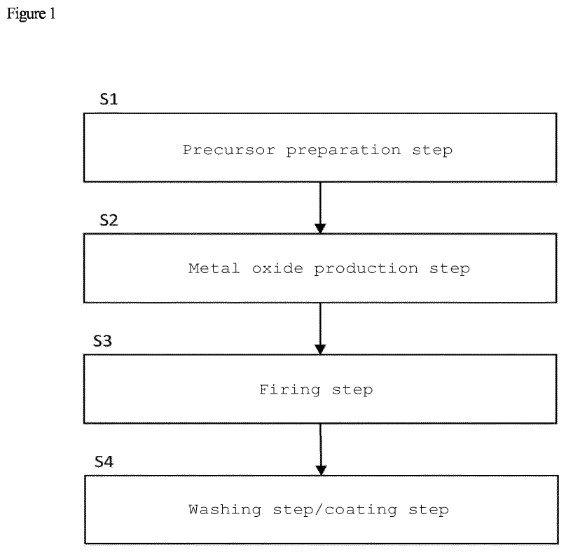

The method for producing the nickel-rich cathode in Embodiment 1 will be described with reference to the flow chart in FIG. 1.

A cathode precursor is prepared in the precursor preparation step (S1). The cathode precursor contains ≥80% (molar ratio) of nickel, and the other elements are cobalt, manganese, aluminum, and other doping elements.

In the precursor preparation step (S1), for example, a nickel salt, a manganese salt, and a cobalt salt are dissolved in deionized water to prepare an aqueous solution in which the molar ratio of the nickel: manganese: cobalt metal elements is 80 to 90:5 to 10:5 to 10. The resulting aqueous solution is added to an alkaline solution to form a suspension, giving a solid product. The resulting solid product is dried to produce the cathode precursor. The precursor may also be obtained by other methods.

The cathode precursor and lithium raw material are mixed in the metal oxide solid raw material production step (S2).

For example, the cathode precursor and lithium salt are mixed and dispersed in an aqueous solvent to form a uniform slurry, which is then dried to obtain a metal oxide solid raw material. The metal oxide solid raw material may also be obtained by other methods.

In the firing step (S3), a cathode precursor containing at least a predetermined amount of nickel, and a metal oxide raw material containing lithium raw material, are fired in a reactor having an atmosphere comprising a gas mixture containing oxygen in the range of 94% by volume to 98% by volume. In this way, a nickel-rich cathode active material is obtained.

The amount of oxygen in the gas mixture is preferably 94% by volume to 98% by volume, more preferably 94% by volume to 97% by volume, even more preferably 95% by volume to 96.5% by volume, and still more preferably 95.5% by volume to 96.5% by volume.

The gas components other than the oxygen in the gas mixture comprise one or more selected from argon, nitrogen, helium, and krypton. Here, one or more gas components other than oxygen means that one or more gases are contained on the order of % by volume. For example, in cases where there is one component other than oxygen, the component may be only argon, or only helium, or only krypton. Here, “only argon” means that the gas contained on the order of % by volume is only argon. The gas components other than oxygen in the gas mixture may also be a combination of argon and nitrogen, argon and helium, or argon and krypton. In cases where there are three gas components other than oxygen in the gas mixture, the components may be a combination of argon, nitrogen, and krypton, for example.

The amount of gas components other than oxygen in the gas mixture is preferably 2% by volume to 5% by volume, more preferably 3% by volume to 5% by volume, and even more preferably 3.5% by volume to 4.5% by volume.

When the gas component other than oxygen in the gas mixture is argon, the amount is preferably 2% by volume to 5% by volume, more preferably 3% by volume to 5% by volume, and even more preferably 3.5% by volume to 4.5% by volume.

When the gas components other than oxygen in the gas mixture are argon and nitrogen, the amount of argon is preferably 2% by volume to 5% by volume, more preferably 2.5% by volume to 4% by volume, and even more preferably 2.75% by volume to 3.5% by volume, and the amount of nitrogen is preferably 0.5% by volume to 2.5% by volume, more preferably 0.5% by volume to 2% by volume, and even more preferably 0.75% by volume to 1.5% by volume. When the gas components other than oxygen in the gas mixture are argon and nitrogen, the amount of argon is in particular preferably 2.75% by volume to 3.5% by volume, and the amount of nitrogen is in particular preferably 0.75% by volume to 1.5% by volume.

When the gas components other than oxygen in the gas mixture are argon and helium, the amount of argon is preferably 2% by volume to 5% by volume, more preferably 2.5% by volume to 4% by volume, and even more preferably 2.75% by volume to 3.5% by volume, and the amount of helium is preferably 0.5% by volume to 2.5% by volume, more preferably 0.5% by volume to 2% by volume, and even more preferably 0.75% by volume to 1.5% by volume.

When the gas components other than oxygen in the gas mixture are argon and krypton, the amount of argon is preferably 2% by volume to 5% by volume, more preferably 2.5% by volume to 4% by volume, and even more preferably 2.75% by volume to 3.5% by volume, and the amount of krypton is preferably 0.5% by volume to 2.5% by volume, more preferably 0.5% by volume to 2% by volume, and even more preferably 0.75% by volume to 1.5% by volume.

In the firing step (S3), the gas mixture may be supplied to the reactor either continuously or intermittently.

In the firing step (S3), the firing temperature may range from 600° C. to 1100° C., preferably from 650° C. to 900° C., and more preferably from 700° C. to 800° C.

In the firing step (S3), the duration of firing may range from 5 to 24 hours, preferably from 8 to 16 hours, and more preferably from 11 to 13 hours.

The method may further comprise a washing step and/or a coating step (S4). The washing step is for removing excess lithium and impurities from the nickel-rich cathode active material that has been obtained in the firing step. The coating step is for coating the nickel-rich cathode active material.

The method for producing the electrode may also comprise an electrode production step for producing an electrode using the nickel-rich cathode material obtained in the above-noted method for producing a nickel-rich cathode.

In this way, an electrode utilizing nickel-rich cathode material can be produced. Conventional methods for producing an electrode for a lithium-ion battery are also available as methods for producing electrodes.

### EXAMPLES

Table 1 shows the proportions (% by volume) of the components of the gas mixture.

TABLE 1

| | Oxygen | Argon | Nitrogen |
|---|---|---|---|
| Example 1 | 96 | 4 | — |
| Example 2 | 96 | 3 | 1 |
| Comparative | 99.999 | — | — |
| Example 1 | | | |
| Comparative | 93 | 7 | — |
| Example 2 | | | |
| Comparative | 96 | — | 4 |
| Example 3 | | | |
| Comparative | 93 | — | 7 |
| Example 4 | | | |
| Comparative | 96 | 1 | 3 |
| Example 5 | | | |
| Comparative | 92 | 5 | 3 |
| Example 6 | | | |

### Production: Firing Step

A cathode precursor (compositional proportions: Ni_{0.8}Mn_{0.1}Co_{0.1}(OH)₂; manufacturer: MTI; amount: 700 mg) and lithium raw material (compositional proportions: LiOH H₂ O; manufacturer: Sigma Aldrich; amount: 334 mg) were mixed using a mortar and pestle. The cathode precursor:lithium raw material proportions (molar ratio) were 1:1.05. The mixture was then placed in a furnace (Program Tubular Electric Furnace TMF Series, manufactured by As One Corporation) and treated for 1 hour at 500° C. The temperature in the furnace was increased to 750° C., and the mixture was fired for 12 hours in an atmosphere consisting of the gas mixture having the above compositional proportions. In this way, a nickel-rich cathode material (specifically, a nickel-rich cathode active material) was obtained.

The gas mixture flow rate was 100 SCCM. The fired nickel-rich material (NMC811) that was obtained was allowed to cool naturally at room temperature (approximately 25° C.) at a rate of approximately 5° C./minute.

A nickel-rich cathode electrode was then produced. The electrode raw material consisted of the resulting nickel-rich cathode material (88% by weight), carbon black (product name: C65; manufacturer: TIMCAL; amount: 7% by weight), and polyvinylidene fluoride (abbreviation: PVDF; manufacturer: Solvay; product name: Solef 5130; amount: 5% by weight). The electrode material was dispersed using N-methyl-2-pyrrolidone (abbreviation: NMP; 1-methyl-2-pyrrolidone, manufactured by FUFIFILM Wako Chemicals) as a solvent, and the ingredients were mixed for 1 hour at 400 rpm in an agate grinding jar. In this way, an electrode slurry was produced.

The resulting electrode slurry was then formed into a uniformly thin layer (150 μm) on an aluminum current collector using a doctor blade (in other words, it was formed by tape casting).

Electrodes (12.7 mm in diameter) were then cut and dried in vacuo for 15 hours at 90° C. CR2032 coin cell batteries were assembled in a glovebox in an argon (Ar) atmosphere using lithium metal as both the reference and counter electrodes.

The electrolyte consisted of 1.0 M LiPF₆ in ethylene carbonate (EC):methyl ethyl carbonate (MEC) (50:50 [v/v]).

Lastly, the resulting coin cell batteries were analyzed by electrochemical galvanostatic measurements. The analysis was conducted in the constant current-constant voltage format (CCCV) (with a 0.1 C cut-off at 4.3V) at a temperature of 25° C. within a voltage window of 3.0 to 4.3V versus Li+/Li at different current density (1 C=200 mAg⁻¹). Cells were formed at 0.1° C. for 3 cycles. All data below are the averages of the results for three different coin cell batteries.

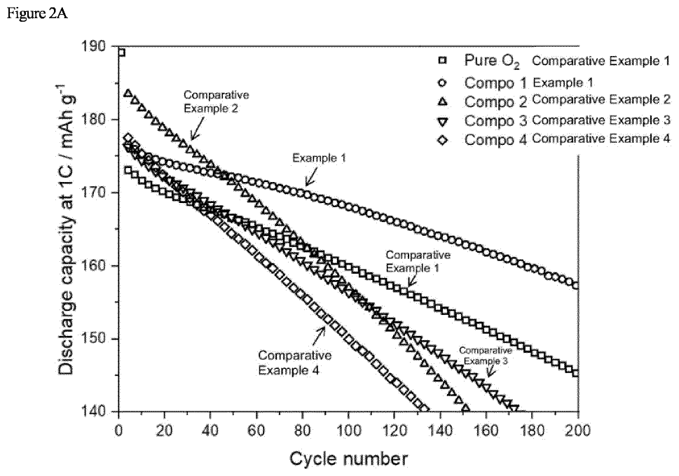

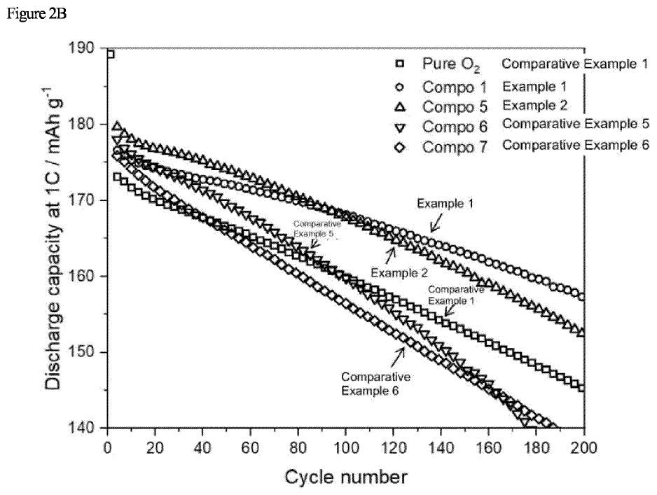

FIGS. 2A and 2B show the long-term cycling (discharge capacity at 1 C) of nickel-rich cathode active materials (NMC811) that were produced using different gas compositions. The BCS-805 battery cycler manufactured by BioLogic was used for the analysis. In FIGS. 2A and 2B, the horizontal axis represents the number of cycles (times), and the vertical axis represents the discharge capacity (discharge capacity per 1 C). FIG. 2A shows the results for a gas mixture containing oxygen and one other component, and FIG. 2B shows the results for a gas mixture containing oxygen and two other components.

Examples 1 and 2 were confirmed to have a higher initial discharge capacity than Comparative Example 1. Examples 1 and 2 were also confirmed to have better long-term cycling than Comparative Examples 1 through 6.

The results for Comparative Examples 3 and 4 also confirmed that increases in nitrogen gas led to a deterioration in long-term cycling. The results for Comparative Examples 5 and 6 confirmed that increases in nitrogen gas led to a deterioration in long-term cycling.

The results for Examples 1 and 2 as well as Comparative Examples 2, 5, and 6 confirmed that argon resulted in a higher initial discharge capacity than pure oxygen (Comparative Example 1).

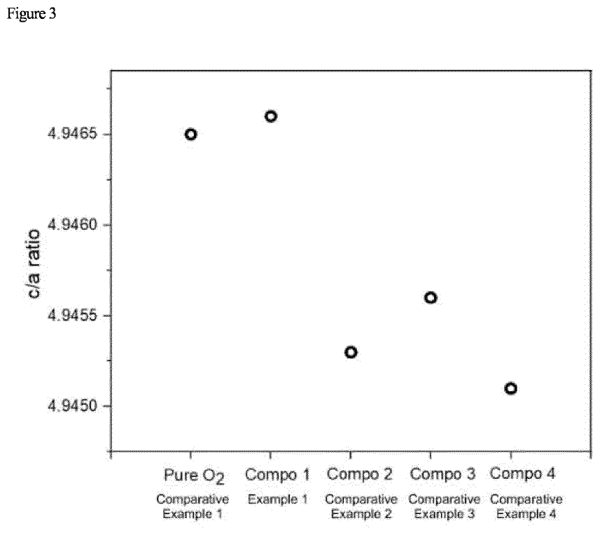

FIG. 3 shows the lattice parameter c/a ratio, as determined by the Rietveld method of X-ray powder difractometry (XRD). The MiniFlex by Rigaku was used for X-ray powder diffractometry. CuKα (λ=1.5406 Å) was used in the conditions of analysis.

Example 1 was comparable to Comparative Example 1. Specifically, it could be inferred that the inclusion of 4% argon in the gas mixture had nearly no effect on Li/Ni cation mixing. On the other hand, it could be inferred that there were crystal defects in Comparative Examples 2, 3 and 4, as compared with Comparative Example 1 and Example 1.

Examples 1 and 2 had higher initial capacity and long term cycling than Comparative Examples 2 through 6.

The composition of the gas mixture in Example 1 was favorable in terms of Li/Ni cation mixing. The nickel-rich cathode of Example 1 was characterized by Li/Ni cation mixing comparable to that of Comparative Example 1 (pure oxygen), suggesting that the 4% argon content shown in Example 1 did not significantly affect the development of Li/Ni cation mixing (see FIG. 3).

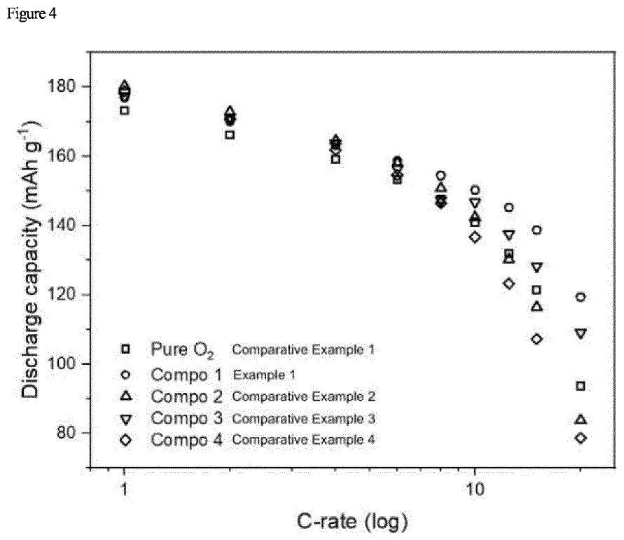

FIG. 4 shows the relative discharge capacity (C-rate) at varying current densities of nickel-rich cathode active materials (NMC811) produced using different gas compositions. In FIG. 4, the horizontal axis represents the C-rate (log scale), and the vertical axis represents the discharge capacity. The BCS-805 battery cycler manufactured by BioLogic was used for the analysis.

The analysis of C-rate performance showed that Example 1 had the highest discharge capacity compared with all other examples and comparative examples.

In Example 1, 67% or more of the discharge capacity could be supplied at 20 C (current density corresponding to 3 minutes of discharge). On the other hand, the discharge capacity at the same rate was less than 50% in the others.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A method for producing a nickel-rich cathode active material, comprising:
a firing step, in which a cathode precursor containing at least a predetermined amount of nickel, and a metal oxide solid raw material containing lithium raw material, are fired in a reactor having an atmosphere comprising a gas mixture containing 94% by volume to 98% by volume of oxygen,
wherein the gas components other than the oxygen in the gas mixture comprise one or more gas selected from argon, nitrogen, helium, and krypton.

2. The method for producing a nickel-rich cathode active material according to claim 1, wherein, the gas component other than oxygen is argon, and an argon content of the atmosphere is 2% by volume to 5% by volume.

3. The method for producing a nickel-rich cathode active material according to claim 1, wherein, the gas components other than oxygen are argon and nitrogen and the argon content of the atmosphere is greater than the nitrogen content of the atmosphere.

4. The method for producing a nickel-rich cathode active material according to claim 3, wherein the nitrogen content is >0% by volume to 2% by volume.

5. (canceled)
